(19) United States
(12) Patent Application Publication
(10) Pub. No.: US 2003/0050874 A1
(43) Pub. Date: Mar. 13, 2003

(54) Delivery confirmation

(76) Inventors: Robert Sesek, Meridian, ID (US); Robert C. Mayes, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/954,607

(22) Filed: Sep. 10, 2001

(51) Int. Cl. G06F 17/60; G06G 1/14

(52) U.S. Cl. 705/29; 705/22

(57) ABSTRACT

A method and system for verifying proper delivery of goods. A seller receives an order to deliver goods to a specified location. The seller hires a shipper to deliver the goods. Upon delivery the physical location of the goods is identified by the shipper and recorded to verify that the goods have in fact been delivered to the specified location. In one embodiment, a universal time is obtained and recorded upon delivery. The identified physical location and the universal time are made available to the buyer and the seller.

### FIELD OF THE INVENTION

The present invention relates generally to a system for confirming delivery, and more particularly, to a system and method for recording a universal time, physical location, and recipient identifier at the point of delivery.

### BACKGROUND OF THE INVENTION

Transporting goods and other deliverables plays a vital role in commerce. Undesirable consequences inevitably arise when goods fail to reach their intended destination as promised. Payroll checks are not distributed, perishables are lost, birthday presents are not received, and business opportunities and commitments are missed. Shippers, such as the United States Postal Service, United Parcel Service, and Federal Express to name only three, provide tracking services so that the party shipping the deliverable and the intended recipient can follow the progress of the deliverable once in the hands of the shipper. Typically, these services are provided over the Internet supplying information such as the intended delivery address, an expected delivery date, and the present or last recorded location of the deliverable. Once delivered, one can obtain a delivery date and time, and in some cases an identifier, such as a signature, of the recipient.

For reasons of convenience, a shipper will often times leave goods on the doorstep or at a receiving dock when an intended recipient is not available. While there exists a risk that someone other than the intended recipient will retrieve the deliverable, that risk is outweighed by the convenience afforded to the intended recipient. For example, a person may order goods to be delivered to a home address. That person is at work during the scheduled delivery time but authorizes the shipper to leave the package on the front porch. Having the package upon returning home is often times more convenient than re-scheduling a delivery time or traveling to the shipper's placer of business to retrieve the goods.

Inevitably, when delivering goods problems do arise. The shipper may leave the goods at the wrong address. Someone other than the intended recipient may take the goods. Or, the goods may merely be misplaced. For example, instead of being left at the receiving dock at the rear of a business, the goods might be mistakenly left just outside the front door. Regardless of the cause, when the intended recipient arrives, the goods cannot be found where expected. Because the shipper leaves the goods without receiving confirmation such as the signature of the recipient, the shipper cannot immediately confirm that the deliverable was left at the correct address or location. Consequently, the shipper cannot determine whether the goods were properly delivered and then stolen or misplaced or whether the shipper mistakenly left the goods at the wrong address.

What is needed is a system and method for identifying and recording the physical location of the goods as they are delivered. The system and method would allow the shipper to verify that the goods were properly delivered as well as when the goods were delivered.

### SUMMARY OF THE INVENTION

The present invention is directed to a method and system for verifying proper delivery of goods. A seller receives an order to deliver goods to a specified location. The seller hires a shipper to deliver the goods. Upon delivery the physical location of the goods is identified by the shipper and recorded to verify that the goods have in fact been delivered to the specified location. In one embodiment, a universal time is obtained and recorded upon delivery. The identified physical location and the universal time are made available to both the buyer and the seller.

### DESCRIPTION OF THE DRAWINGS

FIG. 1 is a schematic representation of a transaction environment for the delivery of goods that includes a buyer, a seller, a shipper, a delivery device, and a ticket.

FIG. 2 is a block diagram further illustrating the logical elements of the ticket according to one embodiment of the present invention.

FIG. 3 is a block diagram further illustrating the logical components of the delivery device according to one embodiment of the present invention.

FIG. 4 is a block diagram of a delivery record according to one embodiment of the present invention.

FIG. 5 is a flow diagram illustrating the transaction for delivery of goods according to one embodiment of the present invention.

### DETAILED DESCRIPTION OF THE INVENTION

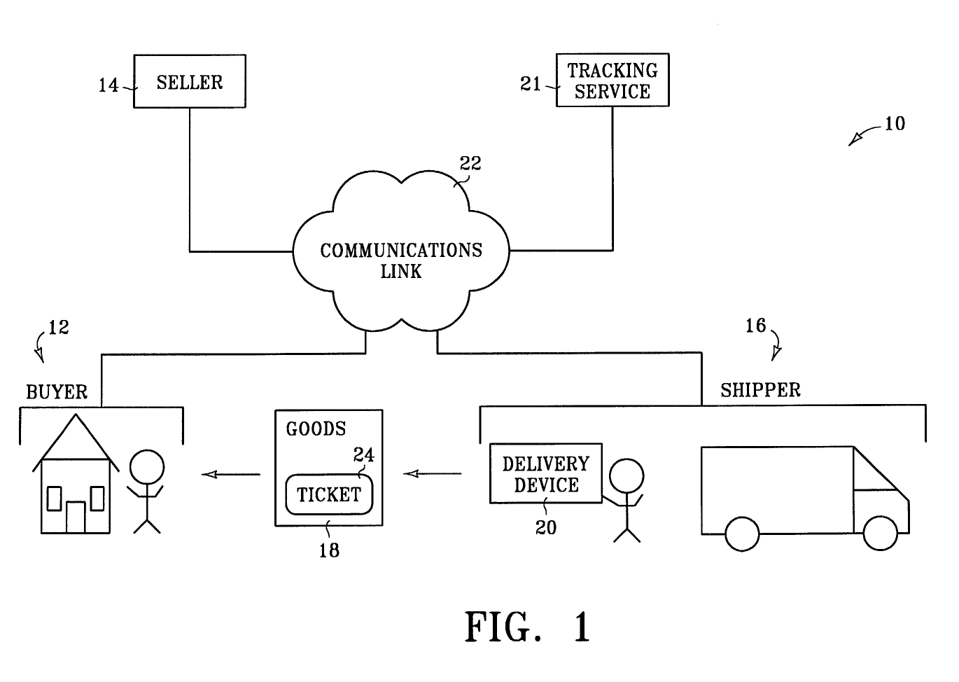

COMPONENTS: FIG. 1 illustrates schematically a transaction environment 10 for the delivery and payment of goods. Although the various embodiments of the invention disclosed herein will be described with reference to environment 10, the invention is not limited to use with environment 10. The invention may be implemented in or used within any environment in which it is necessary or desirable to deliver and confirm delivery of goods. The following description and the drawings illustrate only a few exemplary embodiments of the invention. Other embodiments, forms, and details may be made without departing from the spirit and scope of the invention, which is expressed in the claims that follow this description.

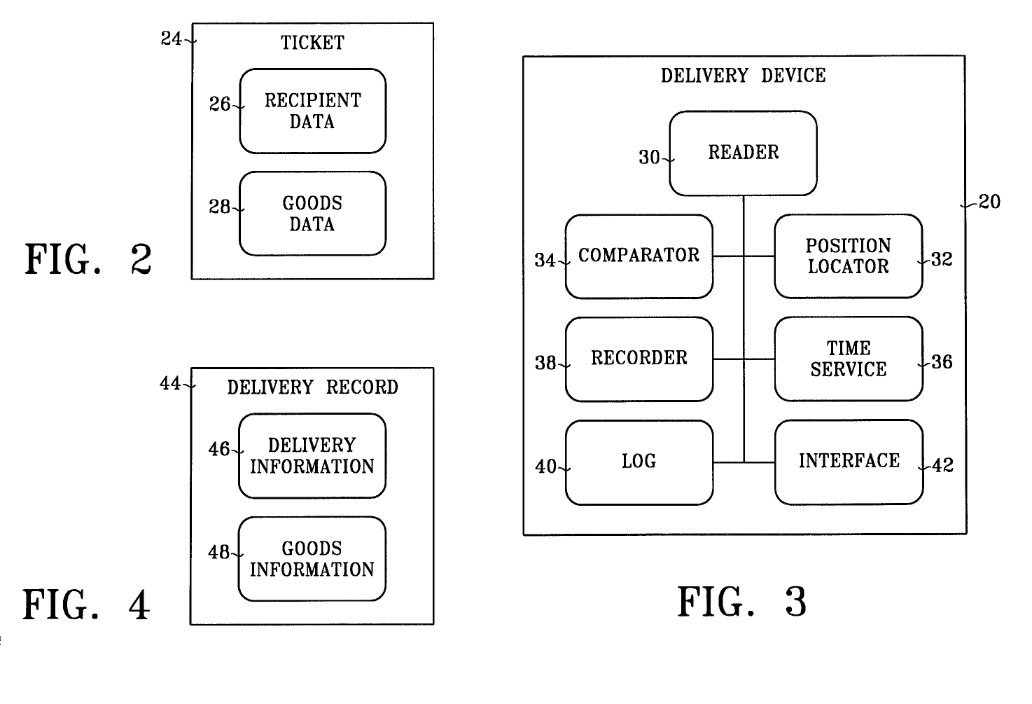

Referring to FIG. 1, environment 10 includes buyer 12, seller 14, shipper 16, goods 18, delivery device 20, tracking service 21, and communications link 22. Buyer 12, seller 14, and shipper 16 represent respectively individuals or business entities ordering, selling, or shipping goods 18. Goods 18 represent generally any deliverable such as a package, letter, or any other item transferable from one location to another. Although FIG. 1 illustrates buyer 12 receiving goods 18, buyer 12 need not be the recipient. Buyer 12 may order goods for delivery to another business or individual. Referring to FIGS. 1 and 2, ticket 24, associated with goods 18, represents generally any source of information representing recipient data 26 and, in some cases, goods data 28. Recipient data 26 typically includes information identifying the intended recipient such as the recipient's name and delivery location. Goods data 28 contains information identifying the goods 18 such as a description of the goods, a purchase price, serial numbers, manufacture dates, and the like.

Delivery device 20 represents generally any combination of hardware and programming capable of reading information from ticket 24. For example, if ticket 24 uses bar codes, then delivery device 20 includes an optical scanner and supporting programming to read bar codes. If ticket 24 instead uses an e-label such as a radio frequency readable identifier (RFID tag) or other electronic file stored in a storage medium affixed to goods 18 or in a storage medium delivered along with goods 18, then delivery device 20 is a computing device capable of receiving and interpreting the electronic file. Many other possibilities exist. Ticket 24 need only contain information relating to the recipient (26) and delivery device 20 need only be capable of reading and processing the information from ticket 24. Ticket 24 need not actually contain data 26 and/or 28, but rather it need only provide information concerning how to access such data 26 and/or 28. For example, if seller 14 stores data 26 and 28 as a record in a central database, then ticket 24 need only contain information identifying that record. One exemplary implementation would be a URL (Uniform Resource Locator). Alternatively, ticket 24 may actually contain recipient and goods data 26 and 28. This data may or may not be compressed and/or encrypted.

Tracking service 21 represents generally any combination of software and/or hardware capable of publishing delivery information. It is envisioned that tracking service 21 will publish the delivery information over the Internet. Delivery information includes information concerning a particular delivery. This information can contain, among other items, the time and data of delivery, data representing the signature of the recipient, and data identifying the goods. Typically shipper 16 provides and maintains tracking service 21.

Communications link 22 interconnects buyer 12, seller 14, shipper 16, and tracking service 21. Communication link 22 represents generally any mode of communication including a cable, wireless, or remote connection via a telecommunication link, an infrared link, a radio frequency link, or any other connector or system that provides electronic or voice communication. Communication link 22 may represent a telephone voice or facsimile link, an intranet, the Internet, or a combination of any of the above.

FIG. 3 further illustrates the logical components of delivery device 20. Delivery device 20 includes reader 30, position locator 32, and comparator 34, time service 36, recorder 38, log 40, and interface 42. Reader 30 represents generally any combination of hardware and programming capable of acquiring and processing information from ticket 24. Position locator 32 represents a combination of hardware and programming capable of communicating with a positioning service to acquire the physical location of goods 18 as ticket 24 is being read. The term positioning service includes any combination of hardware and/or programming capable of supplying locator 32 with the physical location of a point specified by locator 32. It is envisioned that position locator 32 will incorporate a Global Positioning System (GPS) receiver and programming capable of communicating with a positioning service—in this case Global Positioning satellites—to acquire and record the physical location of goods 18 as reader 30 acquires information from ticket 24. Comparator 34 represents generally any programming capable of identifying, from the information obtained from ticket 24 by reader 30, an intended delivery location and to then compare that intended delivery location with the physical location of goods 18 as determined by position locator 32. Comparator 34 then issues an alert indicating discrepancies between the physical location as determined by position locator 32 and the intended delivery location as obtained from ticket 24. The alert may be in the form of an audible or visual signal informing shipper 16 that the physical location of goods 18 does not match the intended delivery location. The intended delivery location may be in the form of an address, physical coordinates, or any other form identifying a particular physical location.

Time service represents any hardware and/or programming capable of identifying a universal time as reader 30 reads ticket 24. A universal time is extremely accurate and can be obtained easily via radio signals which are broadcast worldwide continuously. Using universal time allows for precise time verification which can be translated into any local time easily. This reduces the likelihood of “translation” errors into the local time zone, in that the universal time will always be available in the delivery records. A delivery time reference having worldwide significance allows any interested person to easily ascertain the relative impact of the delivery time upon activities which are local to the delivery, or alternatively which are in distant parts of the world relative to the delivery location. The timing of the delivery, and more relevant to this invention, knowledge of the actual timing of the delivery can be very important information. The examples of first a financial transaction having hard deadlines, and secondly, a delivery of a needed medical item in time for an important medical procedure are only two circumstances that clearly point out the benefits and utility of having ready access to this important information. Recorder 38 represents generally any programming capable of obtaining information from position locator 32, comparator 34, and time service 36 and to record that information in log 40. Log 40 represents a memory area capable of storing electronic data gathered and assembled by recorder 38. Interface 42 represents generally hardware, programming or any combination of hardware and programming capable of transmitting and receiving electronic data allowing delivery device 20 to connect to communications link 22. Interface 42 may incorporate a wireless modem or other similar mechanism allowing delivery device 20 to communicate directly in real time with seller 14 and/or buyer 12. When reading ticket 24, position locator 32 and time service 36 can cause device 20 to transmit the physical location of the goods and the identified universal time to seller 14 and/or buyer 12. “Physical location,” as used herein, includes locations which are defined by street address including city and country information, as well as locations which are defined by geophysical coordinates such as latitude and longitude.

It is envisioned that as goods 18 are delivered, delivery device 20 will read ticket 24 identifying recipient and goods data 26 and 28. Delivery device 20 will generate a delivery record 44, illustrated in FIG. 4, to be stored in log 40 or posted directly to tracking service 21 through interface 42 and communications link 22. Delivery record 44 will contain delivery and goods information 46 and 48. Delivery information 46 will include the physical location obtained by position locator 32, the specified delivery location obtained from ticket 24, any discrepancies found by comparator 34, and perhaps electronic data representing the signature or other identifier of the recipient of goods 18. Goods information 48 may include information identifying goods 18 such as a description, serial number, or other identifier for a package in which goods 18 are delivered. The record can be stored within log 40 and retrieved as necessary. Log 40 is useful when delivery device 20 cannot communicate with seller 14, buyer 12, or tracking service 21 in real time. In such a case shipper 16 can return to a central office or other location where delivery device 20 can connect to communication link 22 and transmit a delivery record to seller 14, buyer 12, and/or tracking service 21.

FIG. 3 illustrates components 30 through 42 as being contained on delivery device 20. However, one or more of the components 32 through 40 may be located elsewhere. For example, position locator 32 may be positioned in a delivery vehicle and configured to communicate via radio frequency or other means with delivery device 20. The same can be said for comparator 34 and time service 36, recorder 38, and log 40. Moreover, while FIG. 1 illustrates tracking service 21 as separate from delivery device 20, tracking service 21 may instead be incorporated in delivery device 20.

The block diagrams of FIGS. 1-4 show the architecture, functionality, and operation of one implementation of the present invention. If embodied in software or other programming, each block may represent a module, segment, or portion of code that comprises one or more executable instructions to implement the specified logical function(s). If embodied in hardware, each block may represent a circuit or a number of interconnected circuits to implement the specified logical function(s).

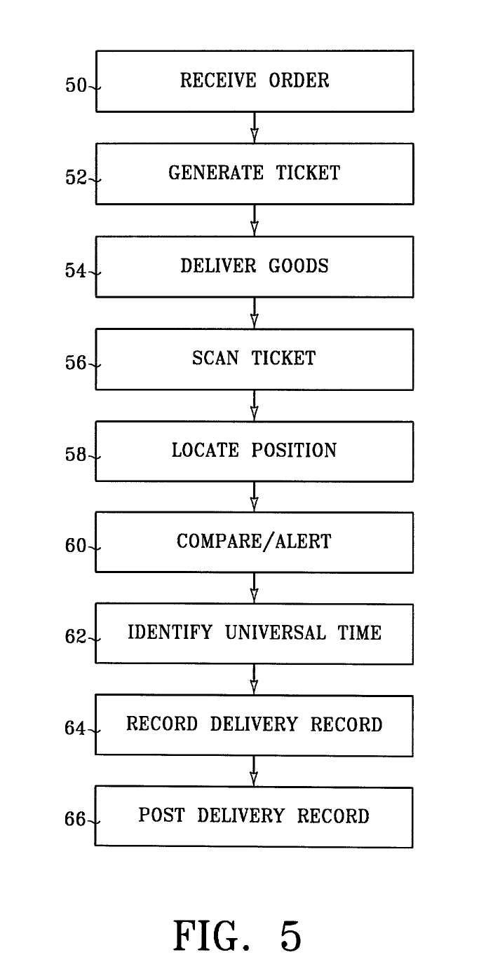

OPERATION: An example of the transaction for the sale and delivery of goods 18 will now be described with reference to the flow diagram of FIG. 5.

Seller receives an order from buyer for specified goods (step 50). The order may be received electronically, via telephone, facsimile, mail, or any other manner. Included in the order is recipient data 26. Seller 14 then creates an order record containing recipient and goods data 26 and 28. Prior to shipment, seller 14 generates a ticket 24 to be delivered with the goods (step 52). The ticket 24 may be affixed to goods 18 but need only be accessible to shipper 16 when goods 18 are delivered. Ticket 24 may either contain information identifying the order record, or the order record or portions thereof may be stored on ticket 24. Seller 14 then delivers or hires a third party shipper 16 to deliver the goods to buyer 12 or another intended recipient (step 54). Upon delivery, shipper 16, using delivery device 20, reads ticket 24 (step 56). Delivery device 20 acquires the physical location of goods 18 (step 58) and then compares the acquired physical location with the intended delivery location obtained from ticket 24—alerting shipper 16 of any discrepancies (step 60). Delivery device 20 then identifies a universal time (step 62) and generates a delivery record 44 (step 64). Shipper 16 may then post the delivery record 44 on tracking service 21 making it available to both seller 14 and buyer 12 (step 66).

Where interface 42 incorporates a wireless modem or other mechanism enabling delivery device 20 to communicate remotely, posting the delivery record may be performed in real time shortly after the ticket 24 is read. Alternatively, interface 42 may incorporate a removable media drive allowing delivery records 44 to be stored on a floppy disk or other non-volatile storage medium. When shipper 16 returns to a central location, delivery records 44 can be transmitted to seller 14 and/or buyer 12. Interface 42 may also enable delivery device 20 to physically connect to a computer network in order transmit delivery records 44. Such a transmission could be made via e-mail or through a direct network connection, or even through traditional mail delivery.

Although the flow chart of FIG. 5 shows a specific order of execution, the order of execution may differ from that which is depicted. For example, the order of execution of two or more blocks may be scrambled relative to the order shown. Also, two or more blocks shown in succession in FIG. 5 may be executed concurrently or with partial concurrence. All such variations are within the scope of the present invention.

The present invention has been shown and described with reference to the foregoing exemplary embodiments. It is to be understood, however, that other forms, details, and embodiments may be made without departing from the spirit and scope of the invention which is defined in the following claims.

What is claimed is:

1. A method for delivering goods comprising:
transporting the goods to a specified location;
upon delivery, acquiring, from a positioning service, a physical location of the goods; and
recording the physical location to verify that the goods have in fact been delivered to the specified location.

2. The method of claim 1, wherein the act of recording comprises posting the physical location to a tracking service.

3. The method of claim 1, further comprising:
generating a ticket containing information relating to the goods;
upon delivery reading the ticket; and
associating the recorded physical location of the goods with the ticket's information.

4. The method of claim 1, further comprising upon delivery, identifying and recording a universal time to provide a delivery time reference having worldwide significance.

5. The method of claim 1, further comprising:
generating a ticket containing information relating to the goods;
upon delivery reading the ticket; and
associating the recorded universal time with the ticket's information.

6. The method of claim 1, further comprising comparing the recorded location with the specified location and issuing an alert indicating discrepancies.

7. A method for delivering goods comprising:
transporting the goods to a specified location;
upon delivery, identifying a universal time; and
recording the universal time to provide a delivery time reference having worldwide significance.

8. The method of claim 7, further comprising:
generating a ticket containing information relating to the goods;
upon delivery, reading the ticket; and
associating the recorded universal time with the ticket's information.

9. A computer program product for verifying proper delivery of goods to a specified location, the product comprising a computer useable medium having machine readable instructions thereon for:
reading a ticket associated with the goods, the ticket having information representing delivery data for the goods;
acquiring from a positioning service a physical location of the goods; and
recording the physical location to verify that the goods have in fact been delivered to the specified location.

10. The product of claim 9, wherein the instructions for recording include instructions for posting the physical location to a tracking service.

11. The product of claim 9, wherein the instructions for recording comprising instructions for associating the recorded physical location with the delivery data.

12. The product of claim 9, comprising further instructions for comparing the recorded physical location with the specified location and issuing an alert indicating discrepancies.

13. The product of claim 12, comprising further instructions for identifying a universal time after the ticket is read and recording the universal time.

14. The product of claim 13, wherein the instructions for recording the universal time comprise further instructions for instructions for associating the recorded universal time with the delivery data.

15. A computer program product for verifying proper delivery of goods, the product comprising a computer useable medium having machine readable instructions thereon for:
reading a ticket associated with the goods, the ticket having information representing delivery data for the goods;
identifying a universal time; and
recording the universal time to provide a delivery time reference having worldwide significance.

16. The product of claim 15, wherein the instructions for recording the universal time comprising instruction for associating the recorded universal time with the delivery data.

17. A system for verifying delivery of goods to a specified address comprising:
a ticket delivered with the goods, the ticket containing information relating to the goods;
a reader operable to read the ticket upon delivery of the goods; and
a locator in communication with the reader, the locator operable to acquire from a positioning service a physical location of the goods as the reader reads the ticket.

18. The system of claim 17, further comprising a recorder in electronic communication with the reader and the position locator, the recorder operable to generate a delivery record associating data representing the physical location of the goods with the information read from the ticket.

19. The system of claim 18, further comprising a log, the recorder being further operable to store one or more delivery records in the log.

20. The system of claim 17, wherein at least some of the information contained in the ticket represents the specified location, the system further comprising a comparator in communication with the reader and the position locator, the comparator operable to compare the physical location with the specified location and to issue an alert indicating discrepancies.

21. The system of claim 17, further comprising a time service in communication with the reader, the time service operable to identify a universal time as the reader reads the ticket.

22. The system of claim 21, further comprising a recorder in electronic communication with the reader and the time serviced, the recorder operable to generate a delivery record associating data representing the universal time with the information read from the ticket.

23. The system of claim 22, further comprising a log, the recorder being further operable to store one or more delivery records in the log.

24. The system of claim 22 further comprising a tracking service, the recorder being further operable to post one or more delivery records to the tracking service.

25. A system for verifying delivery of goods to a specified address comprising:
a ticket delivered with the goods, the ticket containing information goods data; and
a reader operable to read the ticket upon delivery of the goods;
a position locator in communication with the reader operable to acquire from a positioning service a physical location of the goods as the reader reads the ticket;
a time service in communication with the reader, the time service operable to identify a universal time as the reader reads the ticket; and
a recorder in communication with the reader, position locator and time service, the recorder operable to generate a delivery record associating data representing the physical location of the goods and the universal time with information read from the ticket.

26. The system of claim 25, wherein at least some of the information contained in the ticket represents the specified location, the system further comprising a comparator in communication with the reader and the position locator, the comparator operable to compare the physical location with the specified location and to issue an alert indicating discrepancies.
